(19) United States
(12) Patent Application Publication
(10) Pub. No.: US 2025/0217380 A1
(43) Pub. Date: Jul. 3, 2025

(54) SYSTEMS AND METHODS FOR ENHANCED DATA PREPARATION FLEXIBILITY

(71) Applicant: The PNC Financial Services Group, Inc., Pittsburgh, PA (US)

(72) Inventors: Patrick David O'Connor, Rocky River, OH (US); Bobby Melvin Underwood, JR., Shawnee, KS (US); Brian Joseph Rakoci, Moon Township, PA (US); Akhilesh Gorle, Olmsted Falls, OH (US); Megan Elizabeth Dahlinger, Blackstone, IL (US); Mark Martonchik, Pittsburgh, PA (US)

(73) Assignee: The PNC Financial Services Group, Inc., Pittsburgh, PA (US)

(21) Appl. No.: 19/002,359

(22) Filed: Dec. 26, 2024

Related U.S. Application Data
(60) Provisional application No. 63/615,051, filed on Dec. 27, 2023.

(51) Int. Cl. G06F 16/25; G06F 16/245

(52) U.S. Cl. CPC G06F 16/254; G06F 16/245

(57) ABSTRACT

A computer-implemented method for managing large datasets is disclosed. The method may include receiving source data from a data source for staging in a staging database. The method may include storing the source data in the staging database in a source data format. The method may include transmitting the source data from the staging database to a working database. The method may include segmenting the source data into one or more datasets within the working database based on one or more data patterns. The method may include transmitting each dataset to an associated consumption database within a sub-layer. The method may include receiving a request to query the associated consumption database. The method may include executing the query and returning a query result.

### CROSS REFERENCE TO RELATED APPLICATIONS

This application claims the benefit of priority of U.S. Provisional Patent Application No. 63/615,051 filed on Dec. 27, 2023, the contents of which are incorporated herein by reference in their entirety.

### TECHNICAL FIELD

The present disclosure relates generally to systems and methods for an enterprise consumption layer. More specifically the present disclosure relates to data consumption at a large level based on data movement policy controls.

### BACKGROUND

Organizations are increasingly managing large datasets and large amounts of data. Often, this data is stored across various storage systems, and comes from various sources. To ensure that business operate normally, this process needs to be streamlined from the ingestion of data, through the processing of data, and to the outputting of data. One way of streamlining these processes is through a data model that allows organizations to follow their own best practices for data consumption. By incorporating a separate enterprise consumption layer, it may be possible to ensure that the bulk of data processing occurs at the consumption layer, allowing for flexibility in data preparation. This provides flexibility in sharing data across platforms, not exposing certain data sets to a large community, and providing datasets to end users specifically tailored to their business goals and objectives.

There is a need for a system to dynamically receive and manage data across a data integration system.

### SUMMARY

In view of the foregoing, embodiments of the present disclosure provide computer-implemented systems and methods for managing large datasets. The method may include receiving, by at least one processor of a server, source data from at least one data source for staging in a staging database. The method may further include identifying data sources of the received data. The method may further include transmitting the identified data to a working database. The method may further include segmenting the identified data into datasets based on data patterns. The method may further include transmitting each dataset to at least one associated consumption database. The method may further include receiving a request to query the at least one associated consumption database and executing the query on the at least one associated consumption database. The method may further include returning a query result.

In some embodiments, the system may include a processor configured to collect source data from at least one data source. In some embodiments, the source data from at the least one data source may be provided to a staging database. In some embodiments, the data source may be identified for the source data. In some embodiments, the source data may be transmitted to a working database. In some embodiments, the source data may be segmented into datasets based on data patterns. In some embodiments, the source data may be transmitted to at least one associated consumption database. In some embodiments, a request may be received to query the at least one associated consumption database and the query may be executed on the at least one associated consumption database. Then, in some embodiments, a query result may be returned.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that the foregoing general description and the following detailed description are exemplary and explanatory only, and are not restrictive of the disclosed embodiments.

### BRIEF DESCRIPTION OF THE DRAWINGS

The accompanying drawings, which comprise a part of this specification,

illustrate several embodiments and, together with the description, serve to explain the disclosed embodiments. In the drawings:

FIG. 1 illustrates an exemplary system for managing large datasets, consistent with disclosed embodiments.

FIG. 2 illustrates an example system environment for managing large datasets, consistent with the disclosed embodiments.

FIG. 3A illustrates a system environment for managing large datasets.

FIG. 3B illustrates an example system for managing large datasets, consistent with disclosed embodiments.

FIG. 4 is a flowchart illustrating an example process for managing large datasets, consistent with disclosed embodiments.

FIG. 5 illustrates an example system environment for managing large datasets, consistent with the disclosed embodiments.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added or steps may be removed without departing from the envisioned embodiments. Thus, the materials, methods, and examples are illustrative only and are not intended to be limiting.

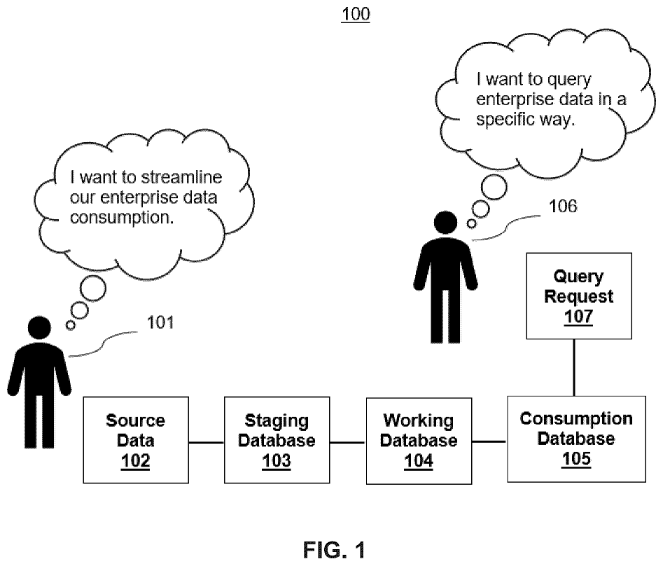

FIG. 1 illustrates an exemplary application of a process for managing large amounts of data and datasets. As illustrated in FIG. 1, entity 101, which may be an individual, a financial institution, or an organization, may need to streamline its data consumption to increase efficiency, manage resources, and provide data to users 106 according to their individual preferences. Individual 106 may work for entity 101 and may wish to view the enterprise data in a way that meets the needs of their enterprise responsibilities. For example, if User 106 reviews loan applications it may wish to query the data in a way that provides a better view of an applicant's financial risk. User 106 may also be an external entity or user that may be provided access to limited information within the enterprise data.

In some embodiments, the source data 102 from at the least one data source may be provided to a staging database 103. The source data 102 may be organized in the staging database 103 as it was organized in the source system. For example, files received from a source system may be stored independently in the staging database 103 to provide an exact replica of the source data 102 for business purposes, such as troubleshooting issues and demonstrating lineage to stakeholders.

In some embodiments, the source data 102 may be transmitted to a working database 104. The working database 104 may read the data from the staging database 103, process the data (e.g., joining data tables, creating derived fields, filtering, etc.), and provide the data to the consumption database 105 as a dataset according to the specific user's preferences. User 106 may then send a query request 107 to the consumption database 105 to view the data in a way that meets their specific needs. Users 106 may have limited access to the consumption database 105 based on one or more permissions, which may be associated with one or more login credentials.

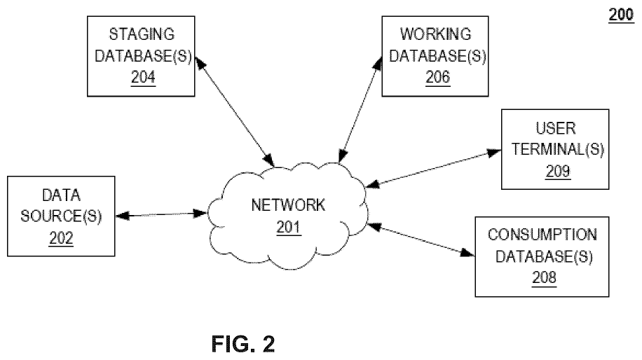

FIG. 2 illustrates an example system 200 for managing a large dataset, consistent with the disclosed embodiments. System environment 200 may include one or more data sources 202, one or more staging databases 204, one or more working databases 206, one or more consumption databases 208, and one or more user terminals 209.

The various components of system 200 may communicate over a network 201. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system environment 200 is shown as a network-based environment, it is to be understood that in some embodiments, one or more aspects of the disclosed systems and methods may also be used in a localized system, with one or more of the components communicating directly with each other.

Data source 202 may be a data source from which system 200 may import data. Staging database 204 may include a data staging layer. In some embodiments, the staging database 204 may be used for loading source data. Working database 206 may include software configured to format data for consumption and query by users based, in some embodiments, on subject matter of the data stored on the working database 206, as described below. Consumption database 208 may include optimized datasets ready to be queried. User terminal 209 may be a user device or user access point that allows a user access to system 200. In some embodiments, a user may be restricted as to which portions of the system they can access. The user device may be any electronic device, such as a smartphone, tablet, or computer, that an individual interacts with to access applications, services, or data.

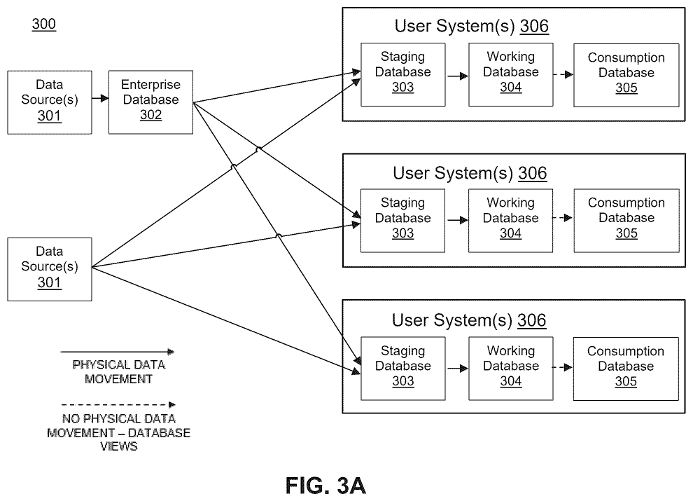

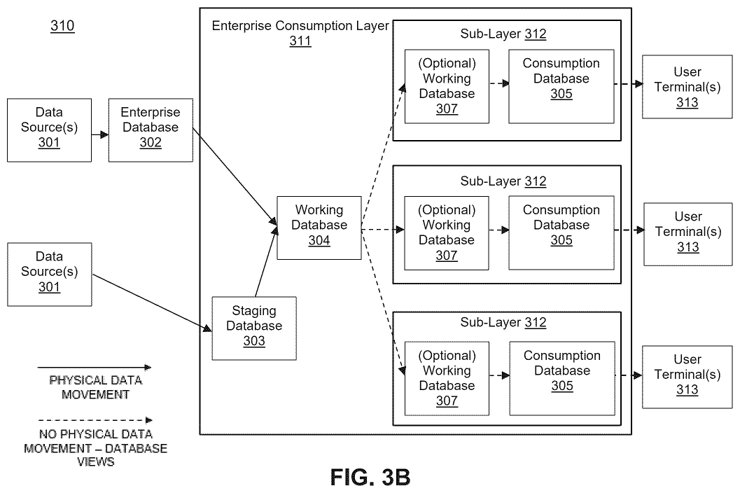

FIG. 3A illustrates a system environment 300 for managing large datasets. In system 300, staging may be performed on individual user systems 306, and data may not be organized for user queries prior to extraction to the staging databases 303. Data sources 301 may either provide data to the enterprise database 302 or directly to the user system's staging databases 303. Each user system 306 may self-serve data extraction from the enterprise database 302 or data sources 301 to the staging databases 303. The physical data may be stored in each user system 306, requiring large amounts of storage. In system 300, the data may be processed on the user system 306, which may cause users to have deep data management skills, or hire specialized personnel with data expertise. The consumption databases 305 and working databases 304 in system 300 are located in user systems 306.

FIG. 3B illustrates an example system 310 for managing large datasets, consistent with disclosed embodiments. System 310 may include an enterprise consumption layer 311, one or more sub-layers 312, one or more data sources 301, an enterprise database 302, a staging database 303, a working database 304, one or more optional working databases 307, one or more consumption databases 305, and one or more user terminals 313.

The primary purpose of the enterprise consumption layer 311 may be to make data easier for a user associated with user terminal 313 to query it. Some users have a specific scope of subject area (e.g., customers, accounts, products, operational systems) that they are interested in, prefer varying levels of details in query results, or wish to query the data in different ways. As such, users may provide one or more data patterns associated with the data. The enterprise consumption layer 311 accommodates each user's preferences by establishing sub-layers 312 for each specific user group that may be decoupled from the globally used consumption area. Each sub-layer 312 may contain database views (i.e., no physical data movement) of data that may represent how a particular user wants to see requested data, which may result in minimizing the transformations that processes would need to perform on the data.

Data may be stored in the enterprise database 302, where it may be organized in the same format that it is received from the data sources 301. Data being ingested from outside of the open relational databases management system (“RDBMS”) may be stored in a staging database 303, where it may be organized in the same format that it is received from the data source 301. The staging database 303 may identify the source of the data, determine whether the data is subject to Data Movement Policy controls, and/or monitor sources from non-enterprise assets. Data Movement Policy controls may include one or more data quality policies, one or more data format policies, or one or more data security policies. The controls may be used to prevent the inclusion of data that does not conform to a data movement policy or may involve redirecting the data to a data ingestion layer (not shown) configured to transform and/or reformat the data to comply with the data movement policy and/or to apply one or more data security enhancements to the data to cause the data to comply with the data movement policy.

The working database 304 may perform data processing and may provide the flexibility of having an area to process and prepare data that is not exposed to the user community. The working database 304 may read the data from the source systems (i.e., data sources 301, enterprise database 302, and/or staging database 303), process the data (e.g., joining data tables, creating derived fields, filtering, etc.), and provide the data to the consumption databases 305 in the sub-layers 312 as a dataset, according to the specific querying preferences of the user with access to the specific sub-layer 312. The sub-layers 312 may include optional working databases 307 for processing data that is specific to the sub-layer's user terminal 313 and providing to the associated consumption database 305 to be queried by user terminals 313. Derived data elements that have an application beyond a single user terminal 313 may remain in the foundational working database 304.

Sub-layers 312 may contain a collection of “database views” that are purpose-built for respective users 313. “Database views,” unlike tables, are not physical representations of data; rather, they are objects that, when queried, execute queries, which may be SQL queries, against other database objects. The sub-layers 312 may contain only “database views” to reduce the costs of managing large datasets, e.g., physically storing the same data on multiple sub-layers 312, or physicalizing data into tables. In some embodiments, physical data may be loaded into sub-layers 312 only when performance necessitates.

Consistent with disclosed embodiments, the enterprise consumption layer 311 may provide datasets to the user terminals 313 in a way that may facilitate user understanding and queries, relative to other dataset providing services. By staging and processing the data in the enterprise consumption layer 311, data may be provided to the sub-layer 312 consumption databases 305 for the user terminal 313 to query without the need to hire data experts, i.e., the data is already organized optimally for each user terminal 313. The enterprise consumption layer 311 may centralize and reduce the costs of staging on behalf of users.

By hosting the sub-layers 312 on the enterprise consumption layer 311 the consumption databases 305 may be closer to the physical data, which may minimize the need to move data from one platform to another, speed up the data processing by removing the need to export data, and reduce the need for users to create their own staging databases 303.

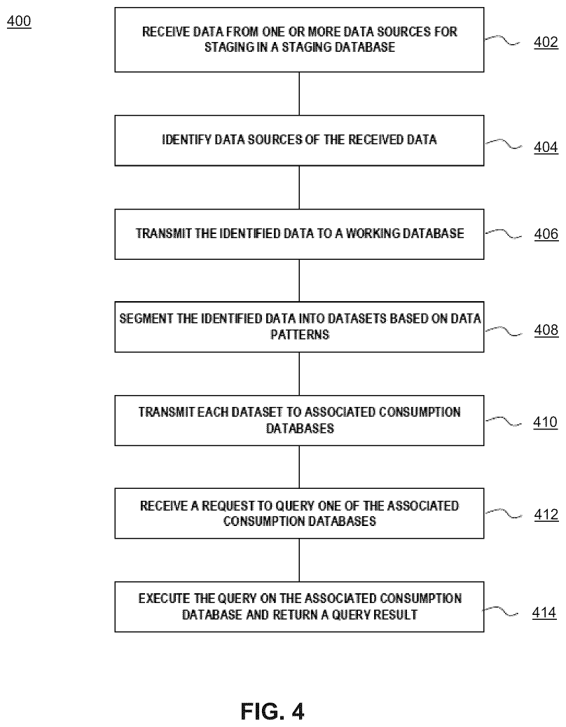

FIG. 4 is a flowchart of an exemplary method for managing a large dataset, consistent with disclosed embodiments. The method may be performed by at least one processing device of a computing device.

In step 402, process 400 may include receiving data from one or more data sources for staging in a staging database, such as staging database 303. Data may originate from within the system, e.g., from a System of Record (which may include data relating to customers, lending accounts, deposit accounts, or capital markets) or may be ingested from outside of the system, e.g., from vendors or other sources. As described above, source data ingested from outside sources such as data sources 301 may be stored in a staging database such as staging database 303 in the format it was received from the data source 301.

In step 404, process 400 may include identifying data sources of the received data. Identifying data sources may involve monitoring non-enterprise assets, ongoing communication with known and/or trusted sources, and/or receiving a parameter indicating a data source.

In step 406, process 400 may include transmitting the identified data to a working database. Consistent with disclosed embodiments, data may be transmitted to a foundational working database 304 where data is processed (by, e.g., joining data tables, creating derived fields, filtering, etc.), and/or to one or more optional working databases 305, located in a sub-layer 312.

In step 408, process 400 may include segmenting the identified data into datasets based on data patterns. Data may be segmented into sub-layers 312 based on subject matter of the data, based on likely queries to data by a user terminal such as user terminal 313, based on the presence or absence of one or more data elements within the data, based on a parameter associated with the data, or some combination thereof. Consistent with disclosed embodiments, the working databases 304 may process the data and provide the processed data in datasets that support queries at the sub-layer 312. Processing the data may include reformatting and/or restructuring the data to facilitate queries associated with the sub-layers 312 and/or may involve transforming the data to conform with one or more data formatting requirements that may be associated with sub-layers 312, consumption databases 305, user terminals 313, or the working database 304 itself. In some embodiments, the working database 304 is responsible for ensuring compliance with one or more universal data formatting requirements so that a common set of data may be accessed by more than one sub-layer 312 and/or more than one user terminal 313. Such compliance may involve transformations to the data to convert non-compliant data into compliant data.

In step 410, process 400 may include transmitting each dataset to at least one associated consumption database, such as consumption databases 305. Consistent with disclosed embodiments, datasets may be transmitted to consumption databases 305 in a format that is specific to the user terminal 313 of the sub-layer 312. In some embodiments, transmission of data from the working database 304 and/or an optional working database 307 to a consumption database 305 may involve the virtual transmission of data, such that physical data is not stored in the consumption database 305, but data stored in the working database 304 is accessed by the consumption database 305, optionally via optional working database 307. Transmission of data may involve ad hoc transmissions of data, such that specifically requested data may be physically transmitted from the working database 304 to the consumption database 305 for temporary use (optionally via optional working database 307), then deleted from the consumption database 305. In some embodiments, a lock may be placed on data stored on the working database 304 when it is being accessed by the consumption database 305 to prevent modification of the data while it is being accessed.

In step 412, process 400 may include receiving a request to query at least one associated consumption database, such as consumption database 305. Each sub-layer 312 may have its own identity and access management entitlements, which may be associated with one or more access roles and may have a special approver if desired by the primary users of the sub-layer 312. Users with access to the sub-layer 312 may query the associated consumption database 305. Entitlements may be associated with access levels to sub-layers 312 and may involve the use of login credentials and/or identity verification associated with the access levels. In some embodiments, data associated with the consumption databases 305 and/or a specific query made by a user terminal 313 may be encrypted, and access to the data may involve the use of decryption. In some embodiments, data access may be limited to certain users and/or user terminals 313 associated with a sub-layer, while in other embodiments, sub-layers 312 may be structured such that all associated user terminals 313 have a same level of access to data accessed by consumption layer 305. In some embodiments, data encryption/decryption may be performed at the working database 304, such that consumption databases 305 accessing data stored on the working database 304 require permissions and/or decryption means (such as public/private key decryption, passwords, digital identity verification, two-factor authentication, and the like) to access particular data elements stored on the working database 304. In some embodiments, encryption levels for data stored on the working database 304 may vary or may be uniform.

In step 414, process 400 may include executing the query on the at least one associated consumption database, such as consumption database 305, and return a query result. Executing the query may involve ad hoc retrieval of data as described herein and/or may involve virtual access to data stored on the working database 304 as described herein. Executing the query may involve one or more data manipulation or transformation steps, which may involve reformatting a subset of data into a table associated with the query to facilitate user access to the query result or to permit the system to return the query result, if the query requires reformatting the subset of data into a table. In some embodiments, the query results may contain confidential or otherwise protected information, and access to the query results may involve further authentication, identity verification, proving of credentials, authorization, or the like. In some embodiments, the query result may be encrypted and viewing the query result using a user terminal such as user terminal 313 may involve decrypting the query result at the user terminal 313.

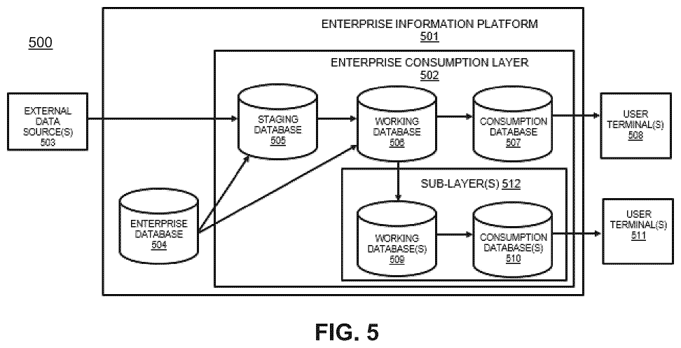

FIG. 5 illustrates an exemplary system 500 for managing large datasets. The system 500 may include an enterprise information platform 501, which may include an enterprise consumption layer 502 according to some embodiments. For example, enterprise information platform 501 may be hosted on a server that may include the enterprise consumption layer 502. External data source 503 may include data sources hosted outside of the enterprise information platform 501. External data may be loaded from the external data source 503 into the staging database 505, which may identify the data source of the received data, implement Data Movement Policy controls, or monitor sources from non-enterprise assets. In the alternative, enterprise data from an enterprise database 504 may be loaded into the staging database 505, or directly into the working database 506. Consistent with disclosed embodiments, data may then be loaded from the staging database 505 into the working database 506, where the bulk of data processing, as described herein, may occur. Working database 506 may be used as an area to process the source data that is not exposed to the user community. In some embodiments, data is segmented into datasets based on data patterns in the working database 506. Once optimized, source data may be loaded into the consumption database 507, where the source data may be queried by a user terminal 508 and return a query result to the user terminal 508. Alternatively, source data may be forwarded to one or more sub-layer working databases 509 in one or more sub-layers 512 for processing. Sub-layer working databases 509 and sub-layer consumption databases 510 may be used for specific datasets that are decoupled from the enterprise system. In some embodiments, the data may be independently managed separately for specific business purposes, to be queried by select user terminals 511.

As shown in FIG. 5, data from external data sources 503 may be staged in the staging database 505 to create an exact replica of the source data as it was supplied from the external data source 503 to assist in, for example, troubleshooting issues and demonstrating lineage to the data source. Enterprise data from the enterprise database 504 may include data that originates within the enterprise. The disclosed embodiments may be implemented to make source data easier for a user to query. For example, data may be organized in the enterprise database 504 and staging database 505 as the data exists in the source systems, not as a user wishes to query the data. In various embodiments, users query the source data in different ways. For example, one user may want highly detailed results, whereas a second user may want summarized results or a specific scope of results. Consistent with disclosed embodiments, the consumption layer may accommodate these distinct queries using sub-layers 512, which may be established for a specific supported user terminal 511.

In instances in which a user wants highly detailed results, returning a query result may include formatting queried data into a table with detailed data and displaying the full table or a significant portion of the table to the user. In instances in which a user wants summarized results, returning a query result may include formatting queried data into a table with query results, but only displaying metadata associated with the table to the user. The metadata resulting from a query for summarized results may include the number of table entries with a given attribute or may include the number of a given attribute. For example, a user desiring summary results may query a database of customer transaction data seeking information about customer transactions by state. The summary results may include the number of transactions in a given state and/or may include the number of states for which the data contains transaction records, showing the number of states in which transactions occurred, according to the data. The query result may additionally and/or alternatively list the states associated with the number of states in which transactions occurred, according to the data. In instances in which a user wants a specific scope of results, returning a query result may include formatting queried data into a table with detailed data and displaying a portion of the table to the user. In the example above, the user may desire to view the amount spent on a given transaction by state. In such instances, the query result may include each transaction amount of each transaction and may group the data by state. But in such instances, the query result may omit data for which the user has expressed no interest, such as merchant data associated with each transaction. In some embodiments, sub-layers 512 are organized to anticipate different types of user queries with varying levels of detail, such that a sub-layer 512 may be organized to omit data elements that a given user is unlikely to express interest in or may be organized to only return summary query results. Sub-layers 512 organized to return summary query results may include additional software directed to summarizing data in ways users of the sub-layer 512 are likely to find helpful, based on common or expected queries.

In some embodiments, sub-layers 512 do not physically store source data and instead provide only a view of the stored data to lower costs of physicalizing data. For example, there may be hundreds of sub-layers 512 providing the same data to specific users, and there may be costs associated with storing the same data in each sub-layer 512, each of which are tailored to provide query results to users according to their preferences, as described herein. As such, data may be stored in one or more databases not found within the sub-layers, such as working database 506. Sub-layer working database 509 may contain addresses or ports to memory locations in working database 506, which may allow sub-layer 512 to access data stored in working database 506 without storing the data in sub-layer working database 509 or sub-layer consumption database 510. In some embodiments, data stored in the working database 506 may be accessed by a user terminal 508 through a consumption database 507 without working through a sub-layer 512. Such direct access may, for instance, involve working database 506 and/or consumption database 507 administrative users, who may require direct access to data stored in working database 506. Such access may be restricted and may involve one or more user authentication steps, one or more permission verification steps, one or more identity verification steps, and/or the like.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method comprising:
receiving, by at least one processor of a server, source data from a data source for staging in a staging database, the source data being in a source data format and having a data subject;
storing the source data in the staging database in the source data format;
transmitting the source data from the staging database to a working database;
segmenting the source data into one or more datasets within the working database based on one or more data patterns received from a user device associated with a user;
transmitting each dataset of the one or more datasets to an associated consumption database within a sub-layer, the sub-layer being associated with the data subject;
receiving a request to query the associated consumption database;
executing the query on the associated consumption database to receive a query result including one or more query result data elements from a dataset of the one or more datasets; and
returning the query result.

2. The method of claim 1, wherein the source data is received from an external source.

3. The method of claim 1, wherein the source data is received from an enterprise source.

4. The method of claim 1, wherein the sub-layer returns the query result according to a user preference received from a second user device associated with a second user.

5. The method of claim 4, wherein the second user is the same as the user.

6. The method of claim 4, wherein access to the sub-layer is restricted to select users.

7. The method of claim 1, wherein the working database has restricted access.

8. The method of claim 1, wherein the staging database identifies the data source.

9. The method of claim 1, wherein the working database is within the sub-layer.

10. The method of claim 1, wherein the source data is stored outside of the sub-layer.

11. A system comprising:
a first memory storing instructions;
a processor configured to execute the instructions to:
receive source data from at least one data source for staging in a staging database, the source data being in a source data format and having a data subject;
store the source data in the staging database in the source data format;
transmit the source data from the staging database to a working database;
segment the source data into one or more datasets within the working database based on one or more data patterns received from a user device associated with a user;
transmit each dataset of the one or more datasets to an associated consumption database within a sub-layer, the sub-layer being associated with the data subject;
receive a request to query the associated consumption database;
execute the query on the associated consumption database to receive a query result including one or more query result data elements from a dataset of the one or more datasets; and
return the query result.

12. The system of claim 11, wherein the working database is within the sub-layer.

13. The system of claim 11, wherein the source data is received from an external source.

14. The system of claim 11, wherein the source data is received from an enterprise source.

15. The method of claim 11, wherein the sub-layer returns the query result according to a user preference received from a second user device associated with a second user.

16. The method of claim 15, wherein the second user is the same as the user.

17. The system of claim 15, wherein access to the sub-layer is restricted to select users.

18. The system of claim 11, wherein the source data is stored outside of the sub-layer.

19. The system of claim 11, wherein the working database has restricted access.

20. The system of claim 11, wherein the staging database identifies the data source.

21-44. (canceled)
